(19) United States
(12) Patent Application Publication
(10) Pub. No.: US 2022/0369805 A1
(43) Pub. Date: Nov. 24, 2022

(54) PORTABLE WORKSTATION

(71) Applicant: Chevis Moguls LLC, Palmdale, CA (US)

(72) Inventor: Raymond Charles Chevis, JR., Palmdale, CA (US)

(21) Appl. No.: 17/710,546

(22) Filed: Mar. 31, 2022

Related U.S. Application Data
(60) Provisional application No. 63/169,569, filed on Apr. 1, 2021.

(51) Int. Cl. A47B 21/03; G06F 1/26

(52) U.S. Cl. CPC A47B 21/0314; G06F 1/26; A47B 2021/0321

(57) ABSTRACT

A portable workstation. The portable workstation comprises a hollowed housing having a closed-end and an opposing open end. The housing defines a compartment for storing a computer keyboard. A hinge is rotatably coupled to an upper surface of the housing. The hinge is adapted to support a mobile device and is adjustable to support the mobile device in various orientations. One or more electrical connectors are coupled to the closed end of the housing. The electrical connectors are in electrical communication with the mobile unit. A charging station is coupled to the upper surface of the housing for fast charging a mobile device. A power cord is coupled to the closed end of the housing. The power cord is electronically coupled to the one or more electrical connectors and the charging station.

### TECHNICAL FIELD

The present disclosure generally relates to computer workstations and, in particular, to portable workstations for mobile devices that also serve as carrying cases.

### SUMMARY OF THE INVENTION

A portable workstation is provided. The portable workstation comprises a hollowed housing having a closed-end and an opposing open end. The housing defines a compartment for storing a computer keyboard. A hinge is rotatably coupled to an upper surface of the housing. The hinge is adapted to support a mobile device and is adjustable to support the mobile device in various orientations. One or more electrical connectors are coupled to the closed end of the housing. The electrical connectors are in electrical communication with the mobile unit. A charging station is coupled to the upper surface of the housing for fast charging a mobile device. Lastly, a power cord is coupled to the closed end of the housing. The power cord is electronically coupled to the one or more electrical connectors and the charging station.

Other devices, apparatus, systems, methods, features and advantages of the disclosure will be or will become apparent to one with skill in the art upon examination of the following figures and detailed description. It is intended that all such additional systems, methods, features and advantages be included within this description, and be protected by the accompanying claims.

### DETAILED DESCRIPTION

A detailed description of the present invention is provided in the attached Appendix 1, the entirety of which is hereby incorporated by reference into this disclosure.

Although the previous description illustrates particular examples of various implementations, the present disclosure is not limited to the foregoing illustrative examples. A person skilled in the art is aware that the disclosure as defined by the appended claims and their equivalents can be applied in various further implementations and modifications. In particular, a combination of the various features of the described implementations is possible, as far as these features are not in contradiction with each other. Accordingly, the foregoing description of implementations has been presented for purposes of illustration and description. Modifications and variations are possible in light of the above description.

What is claimed is:

1. A portable workstation, comprising:
a hollowed housing having a closed end and an opposing open end, the housing defining a compartment for storing a computer keyboard;
a hinge rotatably coupled to an upper surface of the housing, the hinge being adapted to support a mobile device, the hinge being adjustable to support the mobile device in various orientations;
one or more electrical connectors coupled to the closed end of the housing, the electrical connectors being in electrical communication with the mobile unit;
charging station coupled to the upper surface of the housing for fast charging a mobile device;
a power cord coupled to the closed end of the housing, the power cord being electronically coupled to the one or more electrical connectors and the charging station.
